(19) United States
(12) Patent Application Publication
(10) Pub. No.: US 2010/0103264 A1
(43) Pub. Date: Apr. 29, 2010

(54) VEHICLE-SURROUNDINGS DISPLAYING METHOD AND SYSTEM

(75) Inventor: Akira Nagao, Wako (JP)

Correspondence Address: Ditthavong Mori & Steiner, P.C., 918 Prince Street, Alexandria, VA, 22314, US

(73) Assignee: HONDA MOTOR CO., LTD., Tokyo (JP)

(21) Appl. No.: 12/571,314

(22) Filed: Sep. 30, 2009

(30) Foreign Application Priority Data
Oct. 28, 2008 (JP) 2008-277241

(51) Int. Cl. H04N 7/18

(52) U.S. Cl. 348/148; 348/E07.085

(57) ABSTRACT

A vehicle-surroundings displaying method includes obtaining a distorted original image of surroundings of a vehicle. The distorted original image is divided into distorted central, left and right original images. The distorted central original image is corrected to become closer to a central virtual image provided by a virtual image capturing device having a central virtual optical axis to generate a central corrected image. The distorted left original image is corrected to become closer to a left virtual image provided by the virtual image capturing device having a left virtual optical axis to generate a left corrected image. The distorted right original image is corrected to become closer to a right virtual image provided by the virtual image capturing device having a right virtual optical axis to generate a right corrected image. The left and right corrected images are connected to the central corrected image for a display.

### CROSS-REFERENCE TO RELATED APPLICATIONS

The present application claims priority under 35 U.S.C. §119 to Japanese Patent Application No. 2008-277241, filed Oct. 28, 2008. The contents of this application are incorporated herein by reference in their entirety.

### BACKGROUND OF THE INVENTION

1. Field of the Invention

The present invention relates to a vehicle-surroundings displaying method and a vehicle-surroundings displaying system.

2. Discussion of the Background

There is a known method of setting a target position in a distorted vehicle-surroundings image captured with an image capturing device and lineally correcting the vertical distortion of an image portion such as a white line having the same feature amount as that of the target position by vertically shifting multiple columns arranged vertically on the left and right of the target position (Japanese Unexamined Patent Application Publication No. 2006-178667).

However, according to the above known technique, only the distortion of a narrow band-shaped region in the vertical direction of the image is corrected. It may be difficult for the user of the vehicle to have a sense of distance particularly between the vehicle and objects existing near the left and right ends of the image on the basis of the corrected image.

### SUMMARY OF THE INVENTION

According to one aspect of the present invention, a vehicle-surroundings displaying method includes capturing an image of surroundings of a vehicle with a wide-angle image capturing device to obtain a distorted original image of the surroundings. The distorted original image is divided into a distorted central original image, a distorted left original image adjacent to a left side of the distorted central original image, and a distorted right original image adjacent to a right side of the distorted central original image. A central virtual image is provided by a virtual image capturing device in a manner that operates the virtual image capturing device as a central virtual image capturing device having a central virtual optical axis corresponding to an optical axis of the wide-angle image capturing device. The distorted central original image is corrected so as to become closer to the central virtual image, thereby generating a central corrected image. A left virtual image is provided by the virtual image capturing device in a manner that operates the virtual image capturing device as a left virtual image capturing device having a left virtual optical axis tilted to a left side with reference to the optical axis of the wide-angle image capturing device. The distorted left original image is corrected so as to become closer to the left virtual image, thereby generating a left corrected image. A right virtual image is provided by the virtual image capturing device in a manner that operates the virtual image capturing device as a right virtual image capturing device having a right virtual optical axis tilted to a right side with reference to the optical axis of the wide-angle image capturing device. The distorted right original image is corrected so as to become closer to the right virtual image, thereby generating a right corrected image. The left corrected image is connected to the central corrected image in a manner that a right side of the left corrected image is substantially aligned with the left side of the central corrected image, and the right corrected image is connected to the central corrected image in a manner that a left side of the right corrected image is substantially aligned with the right side of the central corrected image, whereby a first corrected image is generated. The first corrected image is displayed on a display device.

According to another aspect of the present invention, a vehicle-surroundings display system includes a wide-angle image capturing device, an image processing device, and a display device. The wide-angle image capturing device is configured to capture an image of surroundings of a vehicle to obtain a distorted original image of the surroundings. The image processing device is configured to divide the distorted original image into a distorted central original image, a distorted left original image adjacent to a left side of the distorted central original image, and a distorted right original image adjacent to a right side of the distorted central original image. The image processing device is configured to provide a central virtual image by a virtual image capturing device in a manner that operates the virtual image capturing device as a central virtual image capturing device having a central virtual optical axis corresponding to an optical axis of the wide-angle image capturing device and configured to correct the distorted central original image so as to become closer to the central virtual image, thereby generating a central corrected image. The image processing device is configured to provide a left virtual image by the virtual image capturing device in a manner that operates the virtual image capturing device as a left virtual image capturing device having a left virtual optical axis tilted to a left side with reference to the optical axis of the wide-angle image capturing device and configured to correct the distorted left original image so as to become closer to the left virtual image, thereby generating a left corrected image. The image processing device is configured to provide a right virtual image by the virtual image capturing device in a manner that operates the virtual image capturing device as a right virtual image capturing device having a right virtual optical axis tilted to a right side with reference to the optical axis of the wide-angle image capturing device and configured to correct the distorted right original image so as to become closer to the right virtual image, thereby generating a right corrected image. The image processing device is configured to connect the left corrected image to the central corrected image in a manner that a right side of the left corrected image is substantially aligned with the left side of the central corrected image and configured to connect the right corrected image to the central corrected image in a manner that a left side of the right corrected image is substantially aligned with the right side of the central corrected image, thereby generating a first corrected image. The display device is configured to display the first corrected image.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic diagram of a vehicle-surroundings monitoring apparatus;

FIGS. 2A and 2B are illustrations related to an image capturing range of a wide-angle camera;

FIG. 3 is a flowchart describing a vehicle-surroundings displaying method according to a first embodiment of the present invention;

FIG. 4 is a flowchart describing a vehicle-surroundings displaying method according to a second embodiment of the present invention;

FIG. 5 is an illustration related to an original image;

FIGS. 6A and 6B are illustrations related to a first image;

FIGS. 7A and 7B are illustrations related to virtual cameras; and

FIG. 8 is an illustration related to a second image.

### DESCRIPTION OF THE EMBODIMENTS

Embodiments will now be described with reference to the accompanying drawings, wherein like reference numerals designate corresponding or identical elements throughout the various drawings.

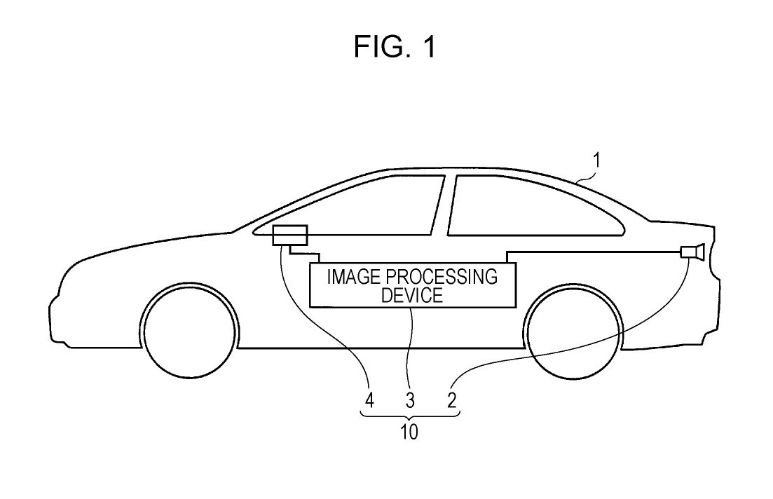

The vehicle-surroundings displaying method is executed by a vehicle-surroundings monitoring apparatus 10 provided in a vehicle 1 illustrated in FIG. 1. The vehicle-surroundings monitoring apparatus 10 includes a camera (wide-angle image capturing device) 2 that captures an image of the area behind the vehicle 1, an image processing device (processor for processing images) 3, and a display device 4 that displays an image processed by the image processing device 3.

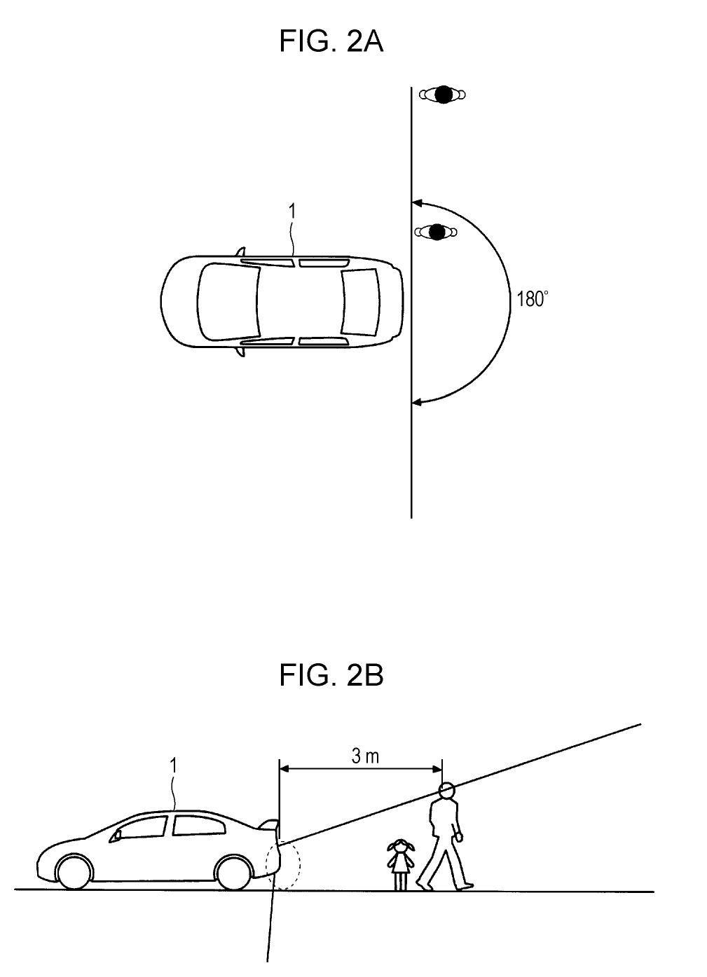

The wide-angle camera 2 is a complementary metal-oxide semiconductor (CMOS) camera having a wide-angle lens whose optical axis is directed toward the area behind the vehicle 1. Instead of the CMOS camera, for example, an infrared camera may be employed as the wide-angle camera 2. An image capturing range of the wide-angle camera 2 when viewed from above the vehicle 1 extends, as illustrated in FIG. 2, within the range of 180 degrees behind the vehicle 1, with reference to the back center of the vehicle 1. That is, the image capturing range of the wide-angle camera 2 when viewed from above the vehicle 1 extends behind the vehicle 1, which is in the rear of a line extending in the vehicle width direction, near the back end of the vehicle 1. The image capturing range of the wide-angle camera 2 when viewed from the lateral side of the vehicle 1 extends, as illustrated in FIG. 2B, from a line at which the head of a person with a height of approximately 170 cm, who is standing approximately 3 m behind the back end of the vehicle 1, can be seen to a line at which an approximately 10-cm portion of the rear bumper of the vehicle 1 can be seen. Alternatively, in place of or in addition to the wide-angle camera 2 provided to capture an image of the area behind the vehicle 1, one or more wide-angle cameras may be provided to capture images of areas in various directions, such as an image of the area in front of or next to the vehicle 1, by directing their optical axes to these areas.

The image processing device 3 includes an analog to digital (A/D) converting circuit that converts an input analog signal into a digital signal, an image memory that stores a digitized image signal, an interface circuit for accessing (reading and writing) data stored in the image memory, a central processing circuit (CPU) that performs various types of processing on an image stored in the image memory, and an electrical control unit (ECU) including a bus connecting these circuits.

A display device of a navigation system, a digital versatile disc (DVD) player, or a television receiver, for example, which is provided in the vehicle 1, may be used as the display device 4.

Now, the vehicle-surroundings displaying method executed by the vehicle-surroundings monitoring apparatus 10 including the foregoing devices will be described.

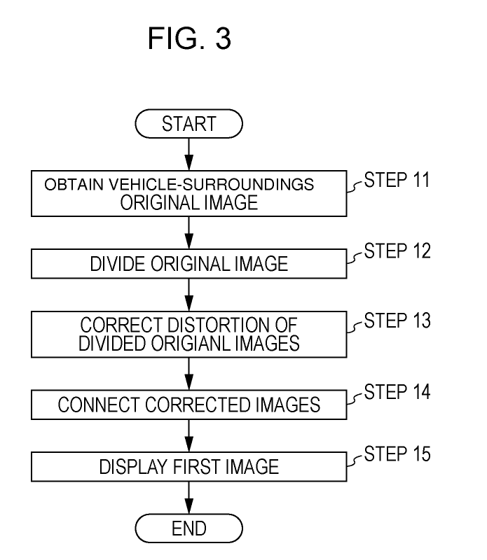

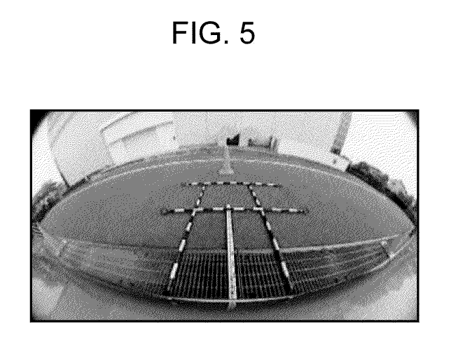

A vehicle-surroundings displaying method according to a first embodiment of the present invention will be described. First, a “vehicle-surroundings image capturing step” of obtaining a distorted original image is executed by capturing an image of the surroundings of the vehicle 1 using the wide-angle camera 2 (STEP 11 in FIG. 3). Accordingly, an original image is obtained by capturing an image of a large area behind the vehicle 1, as illustrated in FIG. 5, for example. In the original image, the degree of distortion of an object included in the image becomes gradually higher from the center toward the surroundings of the image.

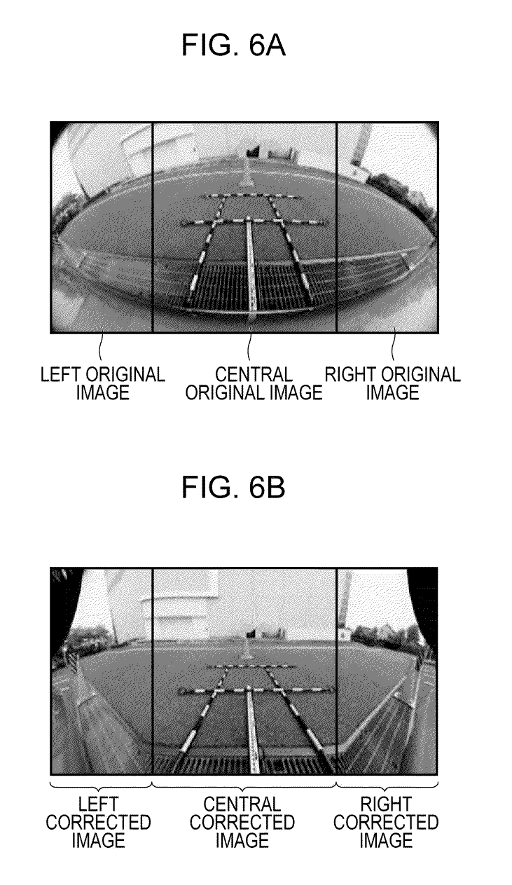

Next, an “image distortion correcting step” is executed. Specifically, the original image is divided into a central original image, a left original image adjacent to the left side of the central original image, and a right original image adjacent to the right side of the central original image (STEP 12 in FIG. 3). Accordingly, the original image illustrated in FIG. 5 is divided into three images, as illustrated in FIG. 6A.

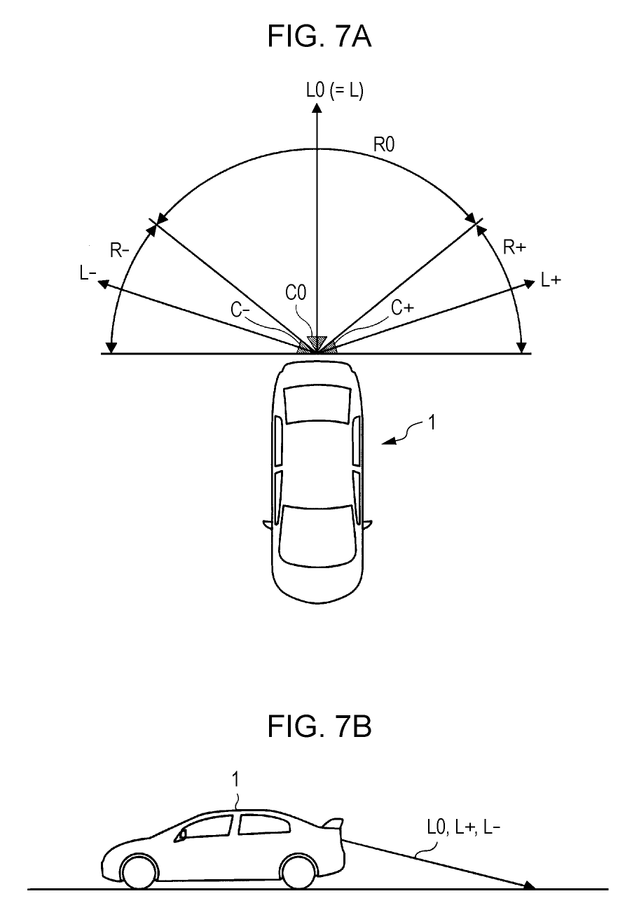

Distortion of the divided images is corrected (STEP 13 in FIG. 3). In correction of the distortion, as illustrated in FIG. 7A, a central virtual camera C0 with a central virtual image capturing range R0 extending in the shape of a fan at the back center of the vehicle 1, a left virtual camera C− with a left virtual image capturing range R− extending in the shape of a fan adjacent to the central virtual image capturing range R0 at the back left of the vehicle 1, and a right virtual camera C+ with a right virtual image capturing range R+ extending in the shape of a fan adjacent to the central virtual image capturing range R0 at the back right of the vehicle 1 are virtually imagined. The central virtual camera C0 has a central virtual optical axis L0 that coincides with the optical axis of the wide-angle camera 2. The left virtual camera C− has a left virtual optical axis L− that is tilted to the left, with reference to the optical axis of the wide-angle camera 2, when viewed from above the vehicle 1. The right virtual camera C+ has a right virtual optical axis L+ that is tilted to the right, with reference to the optical axis of the wide-angle camera 2, when viewed from above the vehicle 1. As illustrated in FIG. 7B, the virtual optical axes L−, L0, and L+ coincide with the optical axis of the wide-angle camera 2, when viewed from the lateral side of the vehicle 1. The virtual cameras C0, C−, and C+ are image capturing devices that capture undistorted images, unlike the wide-angle camera 2. Distortion of the central original image is corrected so that the central original image becomes closer to an undistorted image captured with the central virtual camera C0, thereby generating a “central corrected image”. Distortion of the left original image is corrected so that the left original image becomes closer to an undistorted image captured with the left virtual camera C−, thereby generating a “left corrected image”. Distortion of the right original image is corrected so that the right original image becomes closer to an undistorted image captured with the right virtual camera C+, thereby generating a “right corrected image”. The corrected images are generated in accordance with pixel coordinate converting tables that are set for the respective virtual cameras C−, C0, and C+ and that are stored in the memory of the image processing device 3.

Furthermore, the left corrected image is vertically aligned with the left side of the central corrected image and connected to the central corrected image, and the right corrected image is vertically aligned with the right side of the central corrected image and connected to the central corrected image, thereby generating a “first image” (STEP 14 in FIG. 3). The first image is displayed on the display device 4 (STEP 15 in FIG. 3). Accordingly, for example, as illustrated in FIG. 6B, an image including three image portions is displayed on the display device 4.

According to the vehicle-surroundings displaying method according to the first embodiment of the present invention, an original image captured with the wide-angle camera 2 in which the surroundings of the vehicle 1 are distorted is divided into a “central original image”, a “left original image”, and a “right original image” (STEP 12 in FIG. 3, see FIG. 6A). Distortion of the divided original images is corrected so that the divided original images become closer to undistorted images captured respectively with the central virtual camera C0, the left virtual camera C−, and the right virtual camera C+ (STEP 13 in FIG. 3, see FIGS. 7A and 7B). A “first image” generated by vertically aligning a central corrected image, a left corrected image, and a right corrected image, which are generated by correcting the distortion, and connecting these corrected images is displayed on the display device 4 (STEPs 14 and 15 in FIG. 3, see FIG. 6B). Accordingly, three horizontally-arranged surroundings images of the vehicle 1, such as images as if they were respectively captured with the three virtual cameras C−, C0, and C+ which are directed to the three virtual optical axes L−, L0, and L+ and which capture undistorted images, can be presented to the user (see FIG. 6B). Therefore, even in the case of an object existing near the right end (right virtual image capturing range R+) of the image capturing range of the wide-angle camera 2 (see FIGS. 2A and 2B), an image of the object, such as an image as if it were captured with an image capturing device whose optical axis is directed toward a region in which the object exists and which can capture undistorted images, can be visually recognized in the right-hand portion of the first image, that is, in the right corrected image. Also, the corrected images are vertically aligned and then are placed adjacent to one another. Therefore, even when the image of the object is changed between the adjacent corrected images, vertical positional continuity of the position of the object in the boundary between the adjacent corrected images can be maintained. Thus, the user can understand the positional relationship between the vehicle 1 and an object included in a distorted captured image as if the user were viewing the actual positional relationship.

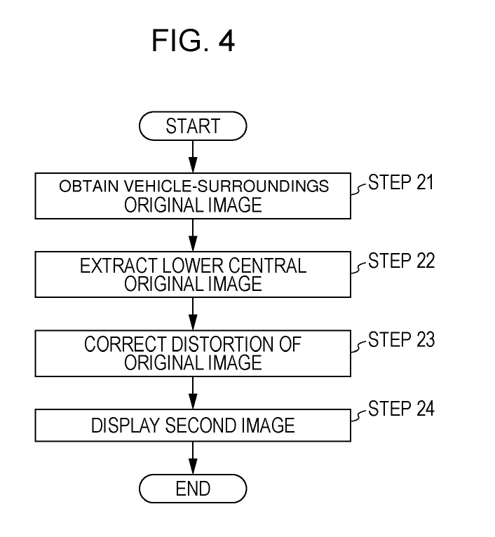

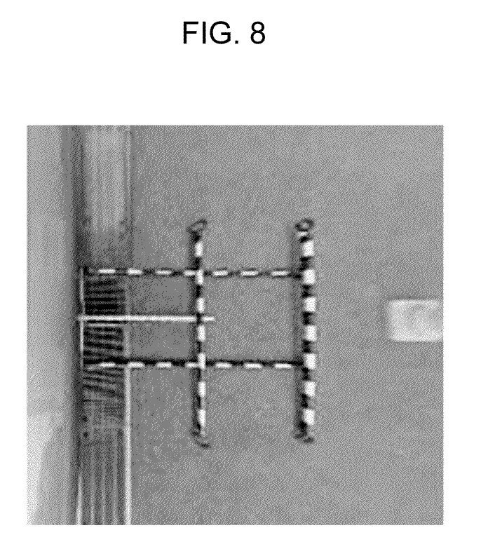

Now, a vehicle-surroundings displaying method according to a second embodiment of the present invitation will be described. First, a “vehicle-surroundings image capturing step” of obtaining a distorted original image is executed by capturing an image of the surroundings of the vehicle 1 using the wide-angle camera 2 (STEP 21 in FIG. 4). This step is the same as that in the first embodiment. An original image such as that illustrated in FIG. 5 is obtained by capturing an image of a large area behind the vehicle 1. Next, an “image distortion correcting step” is executed. Specifically, a lower portion of a central original image is extracted from the original image as a lower central original image (STEP 22 in FIG. 4). Distortion of the lower central original image is corrected (STEP 23 in FIG. 4). In correction of the distortion, a lower central virtual camera with a virtual optical axis that is tilted down below the central virtual camera C0 illustrated in FIGS. 7A and 7B is virtually imagined. Distortion of the lower central original image is corrected so that the lower central original image becomes closer to an undistorted image captured with the lower central virtual camera, thereby generating a “lower central corrected image” as a “second image”. The lower central corrected image is generated in accordance with a pixel coordinate converting table that is set for the lower central virtual camera and that is stored in the memory of the image processing device 3. The second image is displayed on the display device 4 (STEP 24 in FIG. 4). Accordingly, an image of the area near the rear of the vehicle 1, such as that illustrated in FIG. 8, is displayed on the display device 4.

According to the vehicle-surroundings displaying method according to the second embodiment of the present invention, a surroundings image of the vehicle 1, such as an image as if it were captured with a virtual camera that is directed to the lower central virtual optical axis of the vehicle and that captures undistorted images, can be presented to the user (see FIG. 8). Therefore, even in the case of an object existing near a central bottom portion of the image capturing range of the wide-angle camera 2 (see FIGS. 2A and 2B), an image of the object, such as an image as if it were captured with an image capturing device whose optical axis is directed toward a region in which the object exists and which can capture undistorted images, can be visually recognized on the display device 4. Thus, the user can understand the positional relationship between the vehicle 1 and an object included in a distorted captured image as if the user were viewing the actual positional relationship.

In accordance with an operation entered by the user by operating a button or a switch provided in the vehicle 1, in place of or in addition to the first image, the second image may be displayed on the display device 4, or in place of or in addition to the second image, the first image may be displayed on the display device 4.

According to an embodiment of the present invention, there is provided a vehicle-surroundings displaying method including: a vehicle-surroundings image capturing step of obtaining a distorted original image by capturing an image of the surroundings of a vehicle using a wide-angle image capturing device; an image distortion correcting step of generating, using a processor for processing an image, a corrected image by correcting the original image obtained in the vehicle-surroundings image capturing step so that the original image becomes closer to an image captured with a virtual image capturing device that captures an undistorted image; and an image displaying step of displaying, on a display device, the corrected image generated in the image distortion correcting step. In the image distortion correcting step, the original image is divided into a central original image, a left original image adjacent to the left side of the central original image, and a right original image adjacent to the right side of the central original image; distortion of the central original image is corrected so that the central original image becomes closer to an image captured with a central virtual image capturing device serving as the virtual image capturing device with a central virtual optical axis coinciding with an optical axis of the wide-angle image capturing device, thereby generating a central corrected image, distortion of the left original image is corrected so that the left original image becomes closer to an image captured with a left virtual image capturing device serving as the virtual image capturing device with a left virtual optical axis tilted to the left, with reference to the optical axis of the wide-angle image capturing device, thereby generating a left corrected image, and distortion of the right original image is corrected so that the right original image becomes closer to an image captured with a right virtual image capturing device serving as the virtual image capturing device with a right virtual optical axis tilted to the right, with reference to the optical axis of the wide-angle image capturing device, thereby generating a right corrected image; and the left corrected image is vertically aligned with the left side of the central corrected image and connected to the central corrected image, and the right corrected image is vertically aligned with the right side of the central corrected image and connected to the central corrected image, thereby generating a first image as the corrected image.

Accordingly, an original image captured with a wide-angle image capturing device in which the surroundings of a vehicle are distorted is divided into a “central original image”, a “left original image”, and a “right original image”. Distortion of the divided original images is corrected so that the divided original images become closer to undistorted images captured respectively with a “central virtual image capturing device”, a “left virtual image capturing device”, and a “right virtual image capturing device”. The central virtual image capturing device has a central virtual optical axis coinciding with an optical axis of the wide-angle image capturing device. The left virtual image capturing device has a left virtual optical axis tilted to the left, with reference to the optical axis of the wide-angle image capturing device. The right virtual image capturing device has a right virtual optical axis tilted to the right, with reference to the optical axis of the wide-angle image capturing device. A “first image” generated by vertically aligning a central corrected image, a left corrected image, and a right corrected image, which are generated by correcting the distortion, and connecting these corrected images is displayed on a display device. Accordingly, three horizontally-arranged vehicle-surroundings images, such as images as if they were respectively captured with the three virtual image capturing devices which are directed to the three virtual optical axes and which capture undistorted images, can be presented to a user. Therefore, even in the case of an object existing near the right end of an image capturing range of the wide-angle image capturing device, an image of the object, such as an image as if it were captured with an image capturing device whose optical axis is directed toward a region in which the object exists and which can capture undistorted images, can be visually recognized in the right-hand portion of the first image, that is, in the right corrected image. Also, the corrected images are vertically aligned and then are placed adjacent to one another. Therefore, even when the image of the object is changed between the adjacent corrected images, vertical positional continuity of the position of the object in the boundary between the adjacent corrected images can be maintained. Thus, the user can understand the positional relationship between the vehicle and an object included in a distorted captured image as if the user were viewing the actual positional relationship.

In the image distortion correcting step, the central original image may be divided into an upper central original image and a lower central original image that is adjacent to the bottom side of the upper central original image, and distortion of the lower central original image may be corrected so that the lower central original image becomes closer to an image captured with the virtual image capturing device with a lower central virtual optical axis that is vertically tilted down, with reference to the optical axis of the wide-angle image capturing device, thereby generating a lower central corrected image as a second image serving as the corrected image.

Accordingly, a surroundings image of the vehicle, such as an image as if it were captured with a virtual image capturing device that is directed to a lower central virtual optical axis of the vehicle and that captures undistorted images, can be presented to the user. Therefore, even in the case of an object existing near a central bottom portion of the image capturing range of the wide-angle image capturing device, an image of the object, such as an image as if it were captured with an image capturing device whose optical axis is directed toward a region in which the object exists and which can capture undistorted images, can be visually recognized on the display device. Thus, the user can understand the positional relationship between the vehicle and an object included in a distorted captured image as if the user were viewing the actual positional relationship.

In the vehicle-surroundings image capturing step, the original image may be obtained using the wide-angle image capturing device whose optical axis is directed to the back of the vehicle.

Accordingly, the user can understand the positional relationship between the vehicle and an object that exists behind the vehicle and that is included in a distorted captured image as if the user were viewing the actual positional relationship.

Obviously, numerous modifications and variations of the present invention are possible in light of the above teachings. It is therefore to be understood that within the scope of the appended claims, the invention may be practiced otherwise than as specifically described herein.

What is claimed as new and is desired to be secured by Letters Patent of the United States is:

1. A vehicle-surroundings displaying method comprising:
capturing an image of surroundings of a vehicle with a wide-angle image capturing device to obtain a distorted original image of the surroundings;
dividing the distorted original image into a distorted central original image, a distorted left original image adjacent to a left side of the distorted central original image, and a distorted right original image adjacent to a right side of the distorted central original image;
providing a central virtual image by a virtual image capturing device in a manner that operates the virtual image capturing device as a central virtual image capturing device having a central virtual optical axis corresponding to an optical axis of the wide-angle image capturing device;
correcting the distorted central original image so as to become closer to the central virtual image, thereby generating a central corrected image;
providing a left virtual image by the virtual image capturing device in a manner that operates the virtual image capturing device as a left virtual image capturing device having a left virtual optical axis tilted to a left side with reference to the optical axis of the wide-angle image capturing device;
correcting the distorted left original image so as to become closer to the left virtual image, thereby generating a left corrected image;
providing a right virtual image by the virtual image capturing device in a manner that operates the virtual image capturing device as a right virtual image capturing device having a right virtual optical axis tilted to a right side with reference to the optical axis of the wide-angle image capturing device;
correcting the distorted right original image so as to become closer to the right virtual image, thereby generating a right corrected image;
connecting the left corrected image to the central corrected image in a manner that a right side of the left corrected image is substantially aligned with the left side of the central corrected image and connecting the right corrected image to the central corrected image in a manner that a left side of the right corrected image is substantially aligned with the right side of the central corrected image, thereby generating a first corrected image; and
displaying the first corrected image on a display device.

2. The vehicle-surroundings displaying method according to claim 1, further comprising:
dividing the central original image into an upper central original image and a lower central original image adjacent to a bottom side of the upper central original image;
providing a lower central virtual image by the virtual image capturing device having a lower central virtual optical axis vertically tilted down with reference to the optical axis of the wide-angle image capturing device; and
correcting the lower central original image so as to become closer to the lower central virtual image, thereby generating a lower central corrected image as a second corrected image.

3. The vehicle-surroundings displaying method according to claim 1, wherein the wide-angle image capturing device has the optical axis directed to a back side of the vehicle.

4. The vehicle-surroundings displaying method according to claim 2, wherein the wide-angle image capturing device has the optical axis directed to a back side of the vehicle.

5. A vehicle-surroundings displaying system comprising:
a wide-angle image capturing device configured to capture an image of surroundings of a vehicle to obtain a distorted original image of the surroundings;
an image processing device configured,
to divide the distorted original image into a distorted central original image, a distorted left original image adjacent to a left side of the distorted central original image, and a distorted right original image adjacent to a right side of the distorted central original image,
to provide a central virtual image by a virtual image capturing device in a manner that operates the virtual image capturing device as a central virtual image capturing device having a central virtual optical axis corresponding to an optical axis of the wide-angle image capturing device,
to correct the distorted central original image so as to become closer to the central virtual image, thereby generating a central corrected image,
to provide a left virtual image by the virtual image capturing device in a manner that operates the virtual image capturing device as a left virtual image capturing device having a left virtual optical axis tilted to a left side with reference to the optical axis of the wide-angle image capturing device,
to correct the distorted left original image so as to become closer to the left virtual image, thereby generating a left corrected image,
to provide a right virtual image by the virtual image capturing device in a manner that operates the virtual image capturing device as a right virtual image capturing device having a right virtual optical axis tilted to a right side with reference to the optical axis of the wide-angle image capturing device,
to correct the distorted right original image so as to become closer to the right virtual image, thereby generating a right corrected image, and
to connect the left corrected image to the central corrected image in a manner that a right side of the left corrected image is substantially aligned with the left side of the central corrected image and to connect the right corrected image to the central corrected image in a manner that a left side of the right corrected image is substantially aligned with the right side of the central corrected image, thereby generating a first corrected image; and
a display device configured to display the first corrected image.

6. The vehicle-surroundings displaying system according to claim 5, wherein the image processing device is configured,
to divide the central original image into an upper central original image and a lower central original image adjacent to a bottom side of the upper central original image,
to provide a lower central virtual image by the virtual image capturing device having a lower central virtual optical axis vertically tilted down with reference to the optical axis of the wide-angle image capturing device, and
to correct the lower central original image so as to become closer to the lower central virtual image, thereby generating a lower central corrected image as a second corrected image.

7. The vehicle-surroundings displaying method according to claim 5, wherein the wide-angle image capturing device has the optical axis directed to a back side of the vehicle.

8. The vehicle-surroundings displaying method according to claim 6, wherein the wide-angle image capturing device has the optical axis directed to a back side of the vehicle.

9. A vehicle-surroundings displaying method comprising:
means for capturing an image of surroundings of a vehicle with a wide-angle image capturing device to obtain a distorted original image of the surroundings;
means for dividing the distorted original image into a distorted central original image, a distorted left original image adjacent to a left side of the distorted central original image, and a distorted right original image adjacent to a right side of the distorted central original image;
means for providing a central virtual image in a manner that operates a virtual image capturing device as a central virtual image capturing device having a central virtual optical axis corresponding to an optical axis of the wide-angle image capturing device;
means for correcting the distorted central original image so as to become closer to the central virtual image, thereby generating a central corrected image;
means for providing a left virtual image in a manner that operates the virtual image capturing device as a left virtual image capturing device having a left virtual optical axis tilted to a left side with reference to the optical axis of the wide-angle image capturing device;
means for correcting the distorted left original image so as to become closer to the left virtual image, thereby generating a left corrected image;
means for providing a right virtual image in a manner that operates the virtual image capturing device as a right virtual image capturing device having a right virtual optical axis tilted to a right side with reference to the optical axis of the wide-angle image capturing device;
means for correcting the distorted right original image so as to become closer to the right virtual image, thereby generating a right corrected image;
means for connecting the left corrected image to the central corrected image in a manner that a right side of the left corrected image is substantially aligned with the left side of the central corrected image and connecting the right corrected image to the central corrected image in a manner that a left side of the right corrected image is substantially aligned with the right side of the central corrected image, thereby generating a first corrected image; and
means for displaying the first corrected image.
